(19) United States
(12) Patent Application Publication
(10) Pub. No.: US 2015/0312228 A1
(43) Pub. Date: Oct. 29, 2015

(54) REMOTE STATION FOR DERIVING A DERIVATIVE KEY IN A SYSTEM-ON-A-CHIP DEVICE

(71) Applicant: QUALCOMM Incorporated, San Diego, CA (US)

(72) Inventors: Ivan Hugh MCLEAN, Solana Beach, CA (US); Manfred VON WILLICH, San Diego, CA (US)

(73) Assignee: QUALCOMM Incorporated, San Diego, CA (US)

(21) Appl. No.: 14/264,645

(22) Filed: Apr. 29, 2014

(51) Int. Cl. H04L 29/06; H04L 9/32

(52) U.S. Cl. CPC H04L 63/0457; H04L 63/0823; H04L 9/3247; H04L 63/062; H04L 9/3263

(57) ABSTRACT

An integrated circuit may comprise a processor configured to: receive a delegate certificate, wherein the delegate certificate includes a first public key; validate a digital signature of the delegate certificate using a second public key; and generate a derivative key using a secret key securely stored in the integrated circuit and using the first public key as inputs to a key derivation function.

### BACKGROUND

1. Field

The present invention relates generally to generating derivative keys in a system-on-a-chip (SoC) device.

2. Background

A number of “master keys” are provisioned to a system-on-a-chip (SoC) device very early in the lifecycle of the device. These master keys may be owned by one of a number of separate parties. The ability to generate a specific derivative key from a Master Key is controlled via a PKI-based signing model, where one party, typically the chip supplier, holds a root key. The holder of the root key is able to delegate authority, using a delegate certificate, to a party to create specific derivative keys for their own use, while firewalling the party from other parties. Every derivative key has signed metadata that governs the security policy of each derivative key.

There is therefore a need for a technique for preventing the generation of a duplicate derivative key based on weaker metadata in an SoC device.

### SUMMARY

An aspect of the present invention may reside in an integrated circuit, comprising: a processor configured to: receive a delegate certificate, wherein the delegate certificate includes a first public key; validate a digital signature of the delegate certificate using a second public key; and generate a derivative key using a secret key securely stored in the integrated circuit and using the first public key as inputs to a key derivation function.

In more detailed aspects of the invention, the first public key may be of a first party, and the secret key may be a master key of the first party. The secret key may be available to the first party and not available to a second party, and a second private key may be of a second party and may not be available to the first party. The first party may be a service provider and/or an original equipment manufacturer. The second party may be a supplier and/or manufacturer of the integrated circuit.

Another aspect of the invention may reside in an integrated circuit, comprising: means for receiving a delegate certificate, wherein the delegate certificate includes signed metadata governing a security policy; means for validating a digital signature of the delegate certificate using a public key; and means for generating a derivative key using a secret key securely stored in the integrated circuit and using the signed metadata as inputs to a key derivation function.

Another aspect of the invention may reside in a remote station, comprising: a processor configured to: receive a delegate certificate having a digital signature; validate a digital signature using a public key; and generate a derivative key using a secret key securely stored in the processor and using the digital signature as inputs to a key derivation function.

Another aspect of the invention may reside in a remote station, comprising: a processor configured to: receive a delegate certificate, wherein the delegate certificate includes a first public key; validate a digital signature of the delegate certificate using a second public key; and generate a derivative key using a secret key securely stored in the processor and using the first public key as inputs to a key derivation function.

### BRIEF DESCRIPTION OF THE DRAWINGS

FIG. 1 is a block diagram of an example of a wireless communication system.

FIG. 2 is a flow diagram of the method for provisioning a derivative key in a system-on-a-chip (SoC) device, according to the present invention.

FIG. 3 is a block diagram of the method for deriving a derivative key in an SoC device, according to the present invention.

FIG. 4 is a block diagram of a computer including a processor and a memory.

FIG. 5 is a block diagram of a method for generating a digital signature based on a private key.

FIG. 6 is a block diagram of a method for validating a digital signature of a delegate certificate using a public key.

FIGS. 7A-7C are a block diagrams of methods for generating a derivative key using a secret key securely stored in the SoC device and using information from a certificate as inputs to a key derivation function.

FIG. 8 is a flow diagram of another method for deriving a derivative key in an SoC device, according to the present invention.

FIG. 9 is a flow diagram of another method for deriving a derivative key in an SoC device, according to the present invention.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

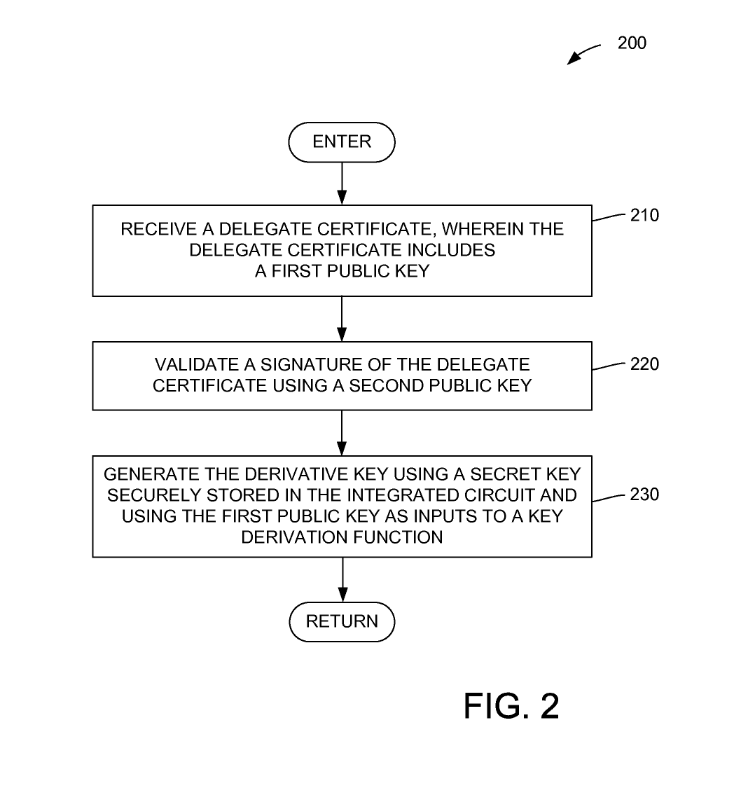

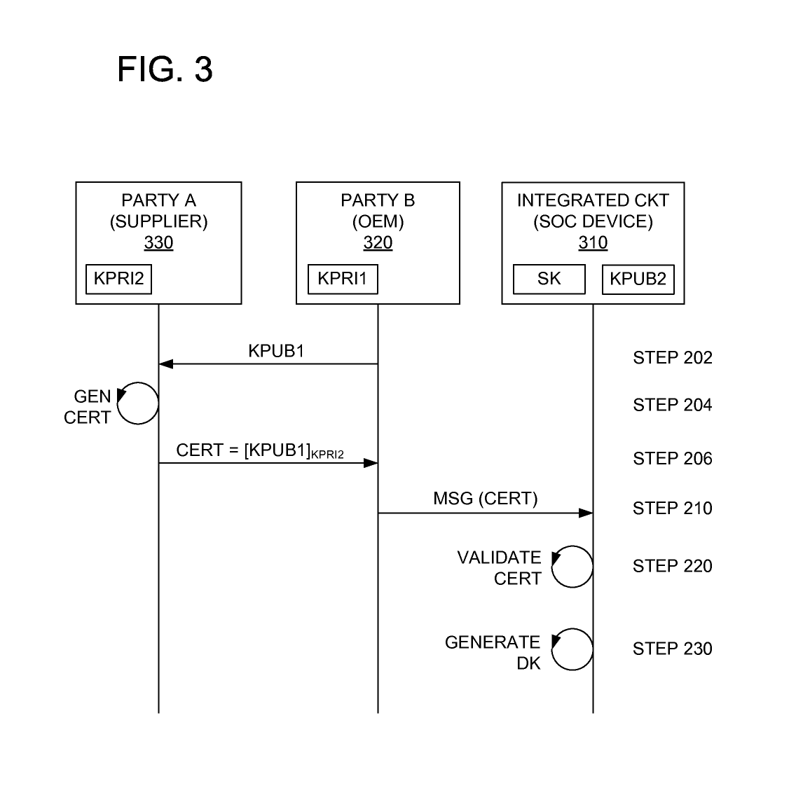

With reference to FIGS. 2 and 3, an aspect of the present invention may reside in an integrated circuit 310 comprising: a processor configured to: receive a delegate certificate CERT (step 210), wherein delegate certificate includes a first public key KPUB1; validate a digital signature of the delegate certificate using a second public key KPUB2 (step 220); and generate a derivative key using a secret key SK securely stored in the integrated circuit and using the first public key as inputs to a key derivation function (KDF) (step 230).

In more detailed aspects of the invention, the first public key KPUB1 may be of a first party B 320, and the secret key SK may be a master key MK of the first party 320. The secret key may be available to the first party and not available to a second party A 330, and a private key KPRI2, corresponding to the second public key KPUB2, may be of the second party and may not be available to the first party. The first party may be a service provider and/or an original equipment manufacturer (OEM). The second party may be a supplier and/or manufacturer of the integrated circuit 310. The integrated circuit may be a system-on-a-chip (SoC) device.

In preliminary operations, the first party 320 may send its public key KPUB1 to the second party 330 (step 202). The second party may generate the delegate certificate CERT (step 204), and forward the generated certificate to the first party (step 206).

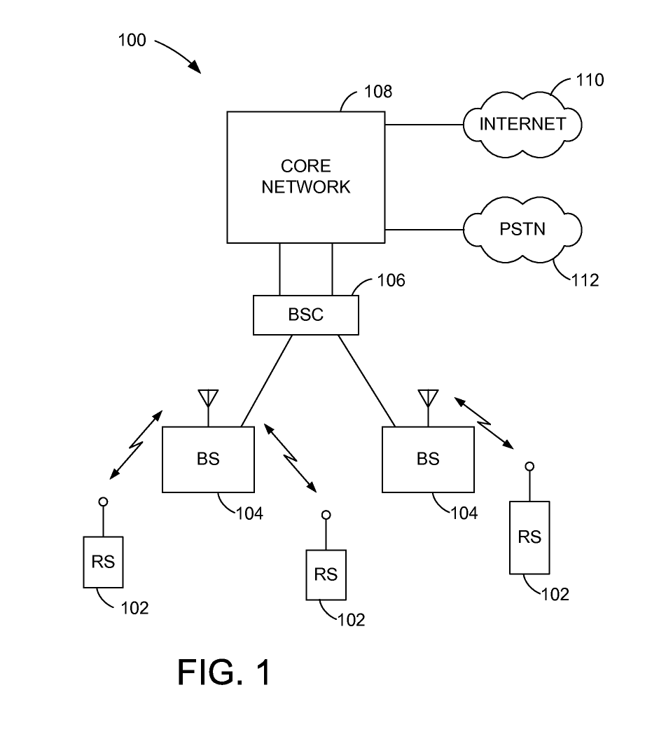

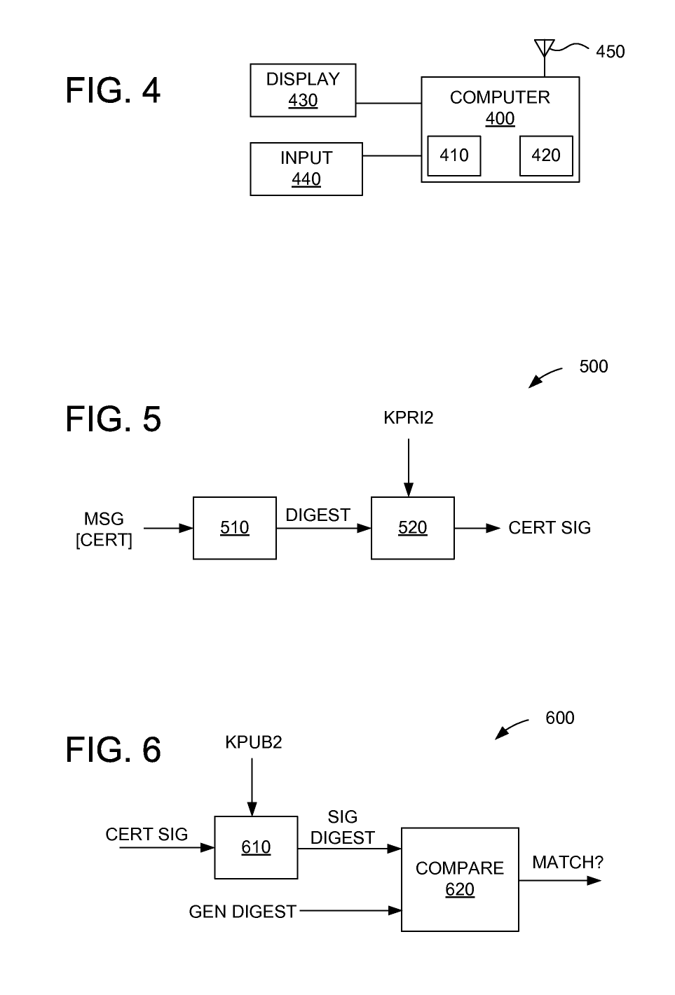

With further reference to FIGS. 1 and 4, a remote station 102 may comprise a computer 400 that includes a processor 410 (in, for example, the integrated circuit 310), a storage medium 420 (such as memory and/or a disk drive), a display 430, and an input such as a keypad 440, and a wireless connection 450 (such as a Wi-Fi connection and/or cellular connection).

A method 500 for generating the digital signature CERT SIG for the delegate certificate CERT in a message MSG from the first party 320 is shown in FIG. 5. The information in the delegate certificate is input into a hash function 510, e.g., SHA 1, SHA2, SHA3, SHA224, SHA256 or SHA512, to generate a digest. The digest is input into an algorithm 520, such as RSA 2048, EC160 or EC224, to generate a certificate signature CERT SIG using the private key KPRI2 of the second party 330. The digital signature may be included as a part of the delegate certificate CERT.

A method 600 for validating the digital signature CERT SIG of the delegate certificate CERT is shown in FIG. 6. A first digest SIG DIGEST is generated from the digital signature CERT SIG of the received delegate certificate using a public key KPUB2 of the second party 330 as a key for an algorithm 610. A second digest GEN DIGEST is generated using information in the delegate certificate as an input into a hash function that is the same as the hash function 510 used to generate certificate signature CERT SIG. The first and second digests are input into a compare function 620. If the two digests match, the digital signature of the delegate certificate is a validated.

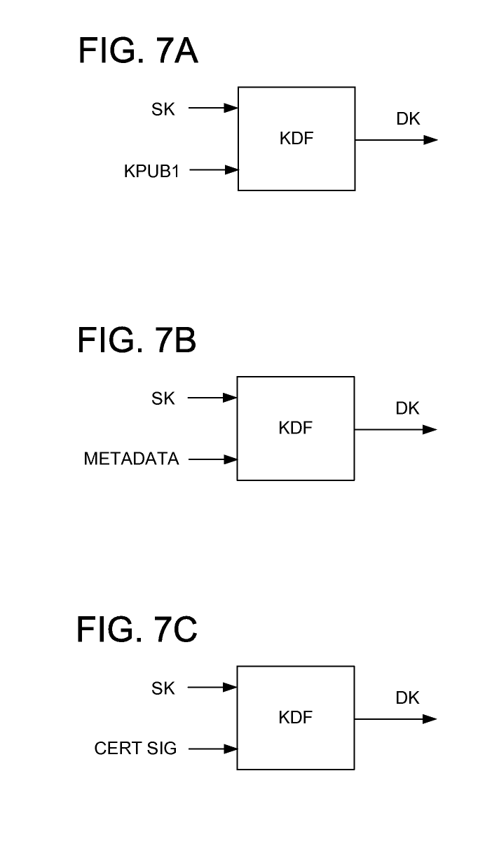

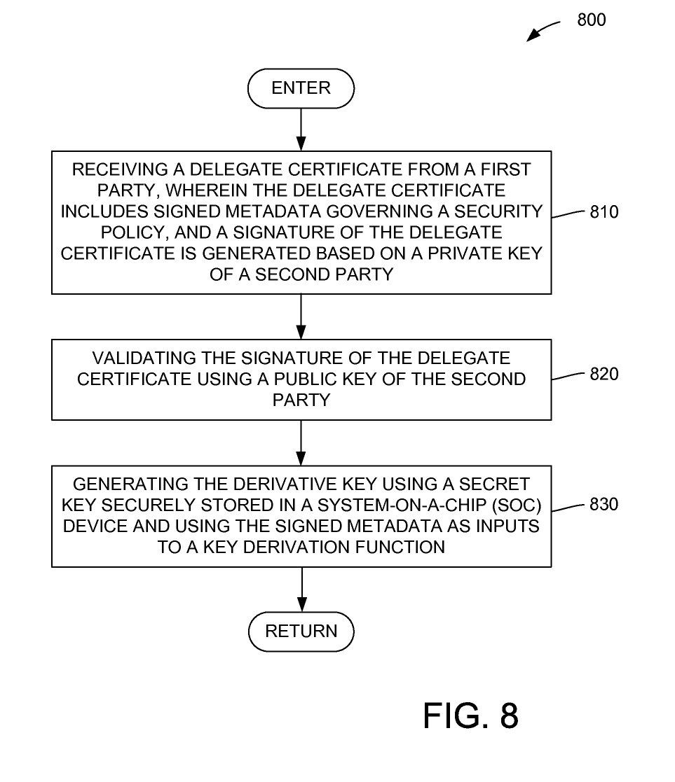

A method for generating the derivative key DK, using the secret key SK securely stored in the SoC device 310 and using the public key KPUB1 of the first party received in the delegate certificate CERT as inputs to the key derivation function KDF, is shown in FIG. 7A. In alternative aspects, the derivative key may be generated using the certificate signature CERT SIG or using signed metadata governing a security policy. Accordingly, a method for generating the derivative key DK using the secret key SK securely stored in the SoC device and using the signed metadata as inputs to the KDF is shown in FIG. 7B. Also, a method for generating the derivative key DK using the secret key SK securely stored in the SoC device and using the digital signature CERT SIG as inputs to the KDF is shown in FIG. 7C.

Another aspect of the invention may reside in an integrated circuit 102, comprising: means 410 for receiving a delegate certificate CERT, wherein the delegate certificate includes signed metadata governing a security policy; means 410 for validating a digital signature of the delegate certificate using a public key KPUB2; and means for generating a derivative key DK using a secret key SK securely stored in the integrated circuit and using the signed metadata as inputs to a key derivation function.

Another aspect of the invention may reside in a remote station 102, comprising: a processor 410 configured to: receive a delegate certificate CERT having a digital signature; validate the digital signature using a public key KPUB2; and generate a derivative key DK using a secret key SK securely stored in the processor and using the digital signature as inputs to a key derivation function.

Another aspect of the invention may reside in a remote station 102, comprising: a processor 410 configured to: receive a delegate certificate CERT, wherein the delegate certificate includes a first public key KPUB1; validate a digital signature of the delegate certificate using a second public key KPUB2; and generate a derivative key DK using a secret key SK securely stored in the processor and using the first public key as inputs to a key derivation function.

Another aspect of the present invention may reside in a method 200 for deriving a derivative key DK in a system-on-a-chip (SoC) device 310. In the method, the SoC device receives a delegate certificate CERT from a first party 320 (step 210). The delegate certificate includes a public key KPUB1 of the first party, and a digital signature of the delegate certificate is generated based on a private key KPRI2 of a second party. The SoC device validates the digital signature of the delegate certificate using a public key KPUB2 of the second party (step 220). The SoC device generates the derivative key using a secret key SK securely stored in the SoC device and using the public key of the first party as inputs to a key derivation function (KDF) (step 230).

Another aspect of the invention may reside in a computer program product, comprising: computer-readable medium 420, comprising: code for causing a computer to receive a delegate certificate CERT from a first party 320, wherein the delegate certificate includes a public key KPUB1 of the first party, and a digital signature of the delegate certificate is generated based on a private key KPRI2 of a second party 330; code for causing the computer to validate the digital signature of the delegate certificate using a public key KPUB2 of the second party 330; and code for causing the computer to generate a derivative key DK using a secret key SK securely stored in a system-on-a-chip (SoC) device and using the public key KPUB1 of the first party as inputs to a key derivation function.

The key derivation functions (KDF) may be the function(s) defined in NIST Special Publication 800-108, which uses a pseudo random function (PRF) in counter (feedback) mode. Alternatively, the KDF may be the function(s) defined in RFC 5869 or ISO-18033-2.

The delegate certificate CERT may be a compact, shorthand form of a digital certificate. A certificate in accordance with the standard X.509 certificate format and other similar formats have many fields that may not be utilized in the techniques of the invention and that may complicate the implementation of the invention in “pure hardware.”

With reference to FIG. 8, another aspect of the present invention may reside in a method 800 for deriving a derivative key DK in an SoC device 310. In the method, the SoC device receives a delegate certificate CERT from a first party 320 (step 810). The delegate certificate includes signed metadata of governing a security policy, and a digital signature of the delegate certificate is generated based on a private key KPRI2 of a second party. The SoC device validates the digital signature of the delegate certificate using a public key KPUB2 of the second party (step 820). The SoC device generates the derivative key using a secret key SK securely stored in the SoC device and using the signed metadata as inputs to a KDF (step 830).

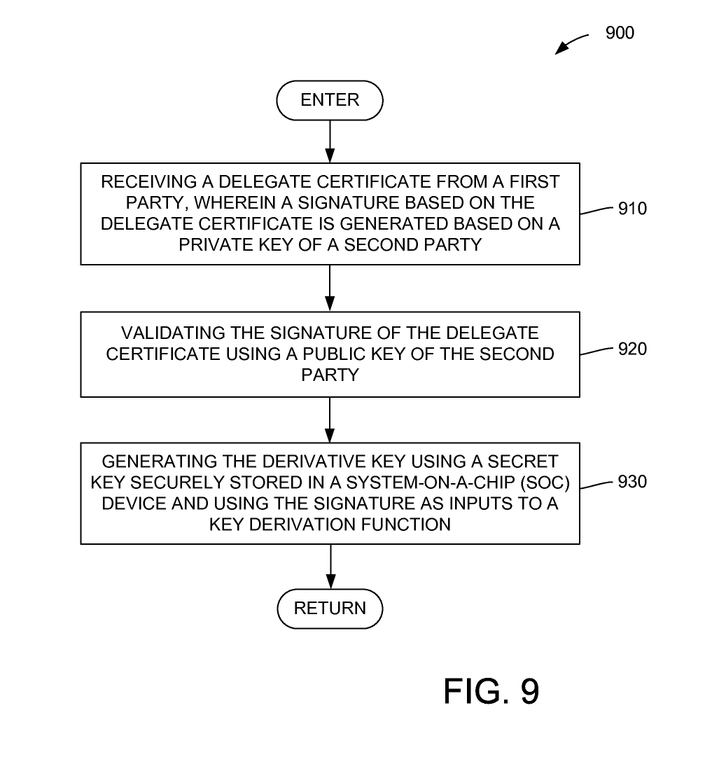

With reference to FIG. 9, another aspect of the present invention may reside in a method 900 for deriving a derivative key DK in a system-on-a-chip (SoC) device 310. In the method, the SoC device receives a delegate certificate CERT from a first party 320 (step 910). A digital signature of the delegate certificate is generated based on a private key KPRI2 of a second party. The SoC device validates the digital signature of the delegate certificate using a public key KPUB2 of the second party (step 920). The SoC device generates the derivative key using a secret key SK securely stored in the SoC device and using the digital signature as inputs to a key derivation function (KDF) (step 930).

The secret key SK may be one of several master keys provisioned in the SoC device. Each master key may be owned by, or may pertain to, a separate party, such as a video service provider, an OEM, etc. A delegate certificate issued to one party should not permit the creation of a delegate key of another party.

With reference to FIG. 1, a wireless remote station (RS) 102 may communicate with one or more base stations (BS) 104 of a wireless communication system 100. The RS may be a mobile station. The wireless communication system 100 may further include one or more base station controllers (BSC) 106, and a core network 108. Core network may be connected to an Internet 110 and a Public Switched Telephone Network (PSTN) 112 via suitable backhauls. A typical wireless mobile station may include a handheld phone, or a laptop computer. The wireless communication system 100 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both non-transitory computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An integrated circuit, comprising:
a processor configured to:
receive a delegate certificate, wherein the delegate certificate includes a first public key;
validate a digital signature of the delegate certificate using a second public key; and
generate a derivative key using a secret key securely stored in the integrated circuit and using the first public key as inputs to a key derivation function.

2. The integrated circuit of claim 1, wherein the first public key is of a first party, and the secret key is a master key of the first party.

3. The integrated circuit of claim 2, wherein the first party is a service provider.

4. The integrated circuit of claim 2, wherein the first party is an original equipment manufacturer.

5. The method of claim 2, wherein the secret key is available to the first party and is not available to a second party, and a second private key is of the second party and is not available to the first party.

6. The integrated circuit of claim 5, wherein the second party is a supplier of the integrated circuit.

7. The integrated circuit of claim 5, wherein the second party is a manufacturer of the integrated circuit.

8. An integrated circuit, comprising:
means for receiving a delegate certificate, wherein the delegate certificate includes signed metadata governing a security policy;
means for validating a digital signature of the delegate certificate using a public key; and
means for generating a derivative key using a secret key securely stored in the integrated circuit and using the signed metadata as inputs to a key derivation function.

9. The integrated circuit of claim 8, wherein the secret key is a master key of a first party.

10. The integrated circuit of claim 9, wherein the first party is a service provider.

11. The integrated circuit of claim 9, wherein the first party is an original equipment manufacturer.

12. The integrated circuit of claim 9, wherein the secret key is available to the first party and is not available to a second party, and a private key is of the second party and is not available to the first party.

13. The integrated circuit of claim 12, wherein the second party is a supplier of the integrated circuit.

14. The integrated circuit of claim 12, wherein the second party is a manufacturer of the integrated circuit.

15. A remote station, comprising:
a processor configured to:
receive a delegate certificate having a digital signature based on the delegate certificate;
validate the digital signature using a public key; and
generate a derivative key using a secret key securely stored in the processor and using the digital signature as inputs to a key derivation function.

16. The remote station of claim 15, wherein the delegate certificate includes another public key of a first party, and the secret key is a master key of the first party.

17. The remote station of claim 16, wherein the first party is a service provider.

18. The remote station of claim 16, wherein the first party is an original equipment manufacturer.

19. The remote station of claim 16, wherein the secret key is available to the second party and is not available to the first party, and the private key of the first party is not available to the second party.

20. The remote station of claim 19, wherein the second party is a supplier of a system-on-a-chip (SoC) device.

21. The remote station of claim 19, wherein the second party is a manufacturer of a system-on-a-chip (SoC) device.

22. A remote station, comprising:
a processor configured to:
receive a delegate certificate, wherein the delegate certificate includes a first public key;
validate a digital signature of the delegate certificate using a second public key; and
generate a derivative key using a secret key securely stored in the processor and using the first public key as inputs to a key derivation function.

23. The remote station of claim 22, wherein the first public key is of a first party, and the secret key is a master key of the first party.

24. The remote station of claim 23, wherein the first party is a service provider.

25. The remote station of claim 23, wherein the first party is an original equipment manufacturer.

26. The remote station of claim 23, wherein the secret key is available to the first party and is not available to a second party, and a private key is of the second party and is not available to the first party.

27. The remote station of claim 26, wherein the second party is a supplier of a system-on-a-chip (SoC) device.

28. The remote station of claim 26, wherein the second party is a manufacturer of a system-on-a-chip (SoC) device.
